(19) United States
(12) Patent Application Publication
(10) Pub. No.: US 2019/0163843 A1
(43) Pub. Date: May 30, 2019

(54) METHOD FOR IDENTIFYING OPTIMUM RUNWAY ORIENTATION

(71) Applicant: Anadolu Universitesi, Eskisehir (TK)

(72) Inventors: Hakan OKTAL, Eskisehir (TK); Nilgün YILDIRIM, Eskisehir (TK)

(73) Assignee: Anadolu Universitesi, Eskisehir (TK)

(21) Appl. No.: 15/828,343

(22) Filed: Nov. 30, 2017

(51) Int. Cl. G06F 17/50

(52) U.S. Cl. CPC G06F 17/5004

(57) ABSTRACT

The present invention relates to a method applied with a computer that allows identification of the optimum runway orientation that produces the highest usability factor and also identification of the usability factor based on the previously identified runway configuration by using an electronic device containing a database, a control unit, a data input interface, a user interface and a display.

### FIELD OF THE INVENTION

The present invention relates to a method that allows identification of the optimum runway orientation that provides the highest usability factor and that enables identification of the usability factors also for two or three different runway configurations predefined by the user. The method developed herein can be used for airport planning and design as intended for identification of the optimum runway orientation/orientations in the airline transport sector.

### BACKGROUND

When constructing a new airport, or when adding a new runway to an existing airport, a technique developed by the United States Federal Aviation Administration (FAA) so-called “Wind Rose” is implemented throughout the world in identification of the optimum runway orientation. As the airplanes must take-off or land in the wind direction, it is of paramount importance to orient the runways at any airport in the dominant wind direction that prevails at such area in terms of flight safety. In particular, a strong cross-wind perpendicular to the take-off or landing direction might prevent safe maneuvering of the airplane to on the runway. The cross-wind becomes even more important for the small aircrafts. Therefore, the International Civil Aviation Organization (ICAO) has defined different permissible cross-wind limits depending on the types and weights of the aircrafts. As can be seen from FIG. 1, each wind blowing from different directions has a cross-wind component depending on the runway. As illustrated in the example provided, the cross-wind component of any wind blowing at a gale force of 20 knots from 60° according to runway orientation shall be 17 knots. The cross-wind component of the wind blowing at angles close to runway orientation will be reduced. The permissible cross-wind limits defined by ICAO are defined according to the cross-wind component.

When identifying the runway orientation, a concept so-called Usability Factor (UF) is used. ICAO defines the Usability Factor as the percentage rate of the time slot when usage of any runway is not restricted due to the cross-wind within the entire time frame for such use, and recommends orientation of the runways so as to achieve minimum 95% at such percentage rate. The wind data of the area for five years at minimum are used in identification of the optimum runway orientation that produces the highest Usability Factor. The wind data is arranged according to the speed, direction and the number of occurrences. Table 1 illustrates a typical example for the wind data furnished by the FAA.

TABLE 1
Example for the Grouped Wind Statistics

| | Hourly Wind Speed Observations, km/s (knots) | | | | | | | | |
|---|---|---|---|---|---|---|---|---|---|
| | 0-5.6 | 7.4-11.1 | 13-18.5 | 20.4-29.6 | 31.5-38.9 | 40.7-50.0 | 51.8-61.1 | 62.9-74.0 | |
| Direction | (0-3) | (4-6) | (7-10) | (11-16) | (17-21) | (22-27) | (28-33) | (34-40) | Total |
| 1 | 469 | 842 | 568 | 212 | | | | | 2091 |
| 2 | 568 | 1263 | 820 | 169 | | | | | 2820 |
| 3 | 294 | 775 | 519 | 73 | 9 | | | | 1670 |
| 4 | 317 | 872 | 509 | 62 | 11 | | | | 1771 |
| 5 | 268 | 861 | 437 | 106 | | | | | 1672 |
| 6 | 357 | 534 | 151 | 42 | 8 | | | | 1092 |
| 7 | 369 | 403 | 273 | 84 | 36 | 10 | | | 1175 |
| 8 | 158 | 261 | 138 | 69 | 73 | 52 | 41 | 22 | 814 |
| 9 | 167 | 352 | 176 | 128 | 68 | 59 | 21 | | 971 |
| 10 | 119 | 303 | 127 | 180 | 98 | 41 | 9 | | 877 |
| 11 | 323 | 586 | 268 | 312 | 111 | 23 | 28 | | 1651 |
| 12 | 618 | 1397 | 624 | 779 | 271 | 69 | 21 | | 3779 |
| 13 | 472 | 1375 | 674 | 531 | 452 | 67 | | | 3571 |
| 14 | 647 | 1377 | 574 | 281 | 129 | | | | 3008 |
| 15 | 338 | 1093 | 348 | 135 | 27 | | | | 1941 |
| 16 | 560 | 1399 | 523 | 121 | 19 | | | | 2622 |
| 17 | 587 | 883 | 469 | 128 | 12 | | | | 2079 |
| 18 | 1046 | 1984 | 1068 | 297 | 83 | | | | 4496 |
| 19 | 499 | 793 | 586 | 241 | 92 | | | | 2211 |
| 20 | 371 | 946 | 615 | 243 | 64 | | | | 2239 |
| 21 | 340 | 732 | 528 | 323 | 147 | 8 | | | 2078 |
| 22 | 479 | 768 | 603 | 231 | 115 | 38 | 19 | | 2253 |
| 23 | 187 | 1008 | 915 | 413 | 192 | | | | 2715 |
| 24 | 458 | 943 | 800 | 453 | 96 | 11 | 18 | | 2779 |
| 25 | 351 | 899 | 752 | 297 | 102 | 21 | 9 | | 2431 |
| 26 | 368 | 731 | 379 | 208 | 53 | | | | 1739 |
| 27 | 411 | 748 | 469 | 232 | 118 | 19 | | | 1997 |
| 28 | 191 | 554 | 276 | 287 | 118 | | | | 1426 |
| 29 | 271 | 642 | 548 | 479 | 143 | 17 | | | 2100 |
| 30 | 379 | 873 | 526 | 543 | 208 | 34 | | | 2563 |
| 31 | 299 | 643 | 597 | 618 | 222 | 19 | | | 2398 |
| 32 | 397 | 852 | 521 | 559 | 158 | 23 | | | 2510 |
| 33 | 236 | 721 | 324 | 238 | 48 | | | | 1567 |
| 34 | 280 | 916 | 845 | 307 | 24 | | | | 2372 |
| 35 | 252 | 931 | 918 | 487 | 23 | | | | 2611 |
| 36 | 501 | 1568 | 1381 | 569 | 27 | | | | 4046 |
| Calm | 7729 | | | | | | | | 7729 |
| Total | 21676 | 31828 | 19849 | 10437 | 3357 | 529 | 166 | 22 | 87864 |

In the table above, the wind observations are grouped according to certain speed ranges and 36 wind directions with 10° intervals. In the “Wind Rose” technique mentioned in the previous paragraphs and developed by the FAA, intertwining circles represent the gale force, while the lines coming from the center and intersecting with such circles indicate the wind direction as illustrated in FIG. 2. The directions are plotted in ranges with 10° intervals, while the circles representing the gale force are plotted in ranges with 16 knot (nautical mile/hour) intervals. The number of wind observations with direction and gale force falling within the respective area are indicated within the cells formed by intersection of the circles and the lines in terms of percentage within overall wind statistics. The number of observations with zero gale force is indicated at the center of the rose also in terms of percentage. When applying the wind rose technique, a transparent template formed by three lines representing the runway is placed on said wind rose. The central line represents the runway center line of the runway, and the two lines on both sides of such line indicate the permissible cross-wind component. In the example provided in FIG. 2, the permissible cross-wind component has been assumed as 15 knots. The runway template placed on the wind rose is rotated until the wind percentages remaining within two exterior lines achieve the maximum value. The direction that incorporate or cover the maximum wind percentage is chosen as the runway orientation. The observations outside the template, on the other hand, are identified as the number of observations that exceed the permitted cross-wind limit for the runway orientation. Dividing the total number of wind observations that the runway template covers in terms of percentage to the total number of observations produces the usability factor. If the value so obtained is less than 95%, then a second runway might be required for the airport. The same process is repeated also for the second runway, and a new value is produced by adding the wind observations that are not within the template of the first runway, but within the template of the second runway to the usability factor of the first runway.

The most significant problem in the wind rose technique is the cells that do not fall completely within the runway template. The method applied here is to identify at which rate the cells falls within the runway template with an eyeball estimate and divide the number of observations given in terms of percentage in such cell to the identified ratio, and add the value so obtained to the usability factor. The problem of partial coverage of the cells by the runway template has been considered as one of the most important sources of error at the Wind Rose Technique developed by the FAA in identification of the optimum runway orientation, and some researchers have developed new models in order to provide a solution for this problem. With the models they developed, Mousa and Mumayiz (2000), Mousa (2001), Mousa (2002), Jia et al. (2004), and Chang (2013) has endeavored to minimize the partial coverage error, and to provide quicker, more reliable and flexible solutions for the problem of identifying the optimum runway orientation [2-6].

All of the studies mentioned above are based on the Wind Rose Technique developed by the FAA with endeavors to eliminate the poor orientations and the sources of errors present at said technique. Moreover, the limited number of studies mentioned above tried to incorporate some new features to the Wind Rose Technique in order to provide flexibility and swift solution capabilities. The most important aspect that escapes from the attention of all researchers is the assumption of the FAA concerning the Wind Rose Technique. The FAA assumed that the number of observations in terms of percentages within each cell on the wind rose has homogenous distribution. That is to say, when we recall the fact that each cell each cell is subdivided with wind speed intervals of 16 knots, the accuracy of the Wind Rose Technique shall be reduced further in identification of the optimum runway orientation at the wind statistics especially where the gale forces doesn't have homogenous distribution (where the number of strong wind observations and dominant wind directions is high). all of the previous studies conducted as regards identification of the optimum runway orientation acknowledged the assumption propounded by the FAA (1989) without considering any changes thereto, and the proposed models were built on such assumption [1]. Therefore, all models so developed contain the error arising from such assumption.

In the model they developed, Oktal and Yildirim (2014) provided a partial solution to the aforementioned problem [6]. Such model with limited use, however, contains some deficiencies, which leads to failure to eliminate the error arising from the FAA assumption completely.

### BRIEF SUMMARY OF THE INVENTION

The objective of the invention is to provide a method that enables identification of the optimum runway orientation by using the wind statistics containing data on speed, direction and number of occurrences directly at the analyses. In other words, each wind observation has been considered individually when calculating the usability factor and the optimum runway orientation. In this manner, the problem of partial coverage of cells that emerge at the Wind Rose Technique have been eliminated completely. With the method developed herein, the problem concerning identification of the optimum runway orientation has been solved by employing a different approach than the Wind Rose Technique and without requiring the aforementioned assumption made by the FAA. Due to these reasons, the method of the invention qualifies as the method that produces the most accurate results as developed until today.

Another objective of the present invention is to provide a method that further allows identification of the usability factors also for two or three different runway configurations predefined by the user as well as identification of the optimum runway orientation that produces the highest usability factor. As the wind is not the sole factor considered in identification of the optimum runway orientation, the runway orientation that produces the highest usability factor value might not be the optimum orientation in some cases. Restrictions such as elevations or large-scale settlements along the take-off and landing path, the rough terrain structure of the land on which the runway will be constructed, flight path interceptions between the airports and the runways, etc. might necessitate choosing another runway orientation than the runway orientation that produces the highest usability factor. In such case, an adequate runway orientation that would eliminate aforementioned restrictions will be identified. If the usability factor falls under 95%, then it might be necessary to construct a second runway, thus identify a second orientation. Likewise, one might want to analyze whether a triple runway configuration with pre-identified orientations offers the 95% usability factor. The method of the invention features flexible usage and is able to calculate the usability factors for two or three different runway configurations pre-defined by the user as well as identification of the optimum runway orientation that produces the highest usability factor. It is contemplated that a method where different options can be analyzed in this manner would be extremely preferable by the airport planners and designers.

In conclusion, the method of the invention not only produces more accurate results when compared to the previously developed models as it eliminates the sources of error in the classical Wind Rose Technique, but also offers the flexibility to analyze different runway layout scenarios based on desired cross-wind limits.

The method of the invention generates solutions for two different types of analyses. The first type of analysis calculates the optimum runway configuration that produces the highest usability factor automatically. In the second analysis method, on the other hand, the usability factor is calculated according to the previously identified runway orientations where it is possible to determine whether the selected runway orientations are suitable. The method of the invention is capable of producing solutions for up to three runway configurations by virtue of this second analysis method.

### BRIEF DESCRIPTION OF THE DRAWINGS

The method with computer applications provided for achieving the objectives of the present invention is illustrated in the figures attached hereto, in which;

FIG. 1 is the illustration of transition from wind speed to the cross-wind component.

FIG. 2 is the illustration of the Wind Rose Technique developed by the FAA.

FIG. 3 illustrates identification of the orientations covered by the runway template.

FIG. 4 is the illustration of the principle for finding the wind observations covered by two runway templates.

FIG. 5 is the flow chart of the method of the invention that enables identification of the optimum runway orientation or orientations.

FIG. 6 is the flow chart of the method of the invention that enables identification of the usability factor depending on the pre-determined runway configuration.

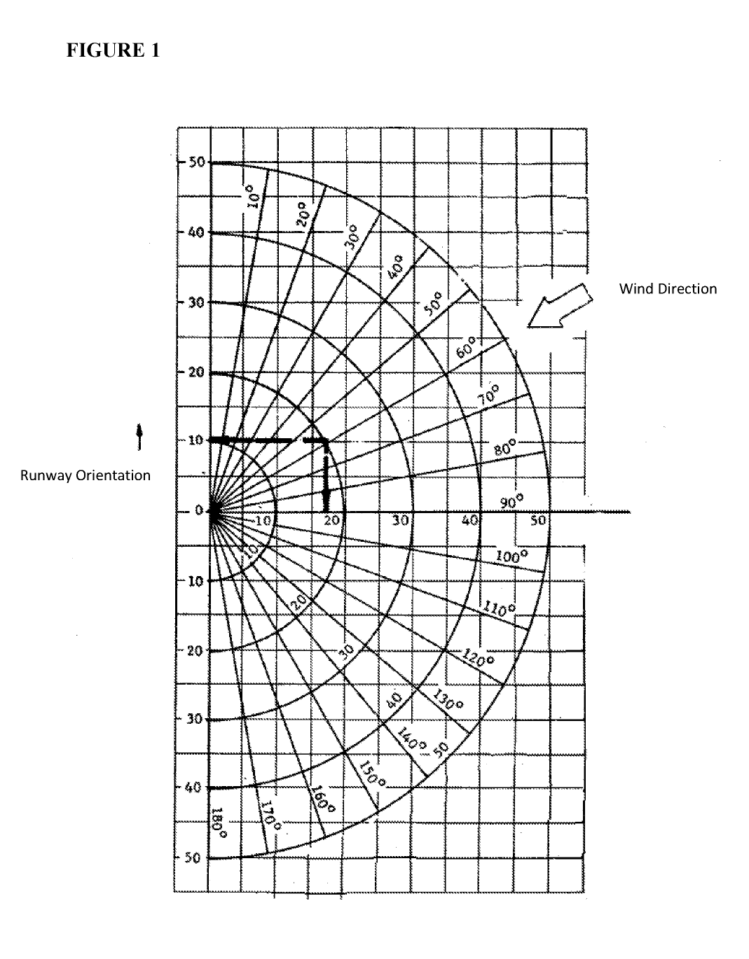

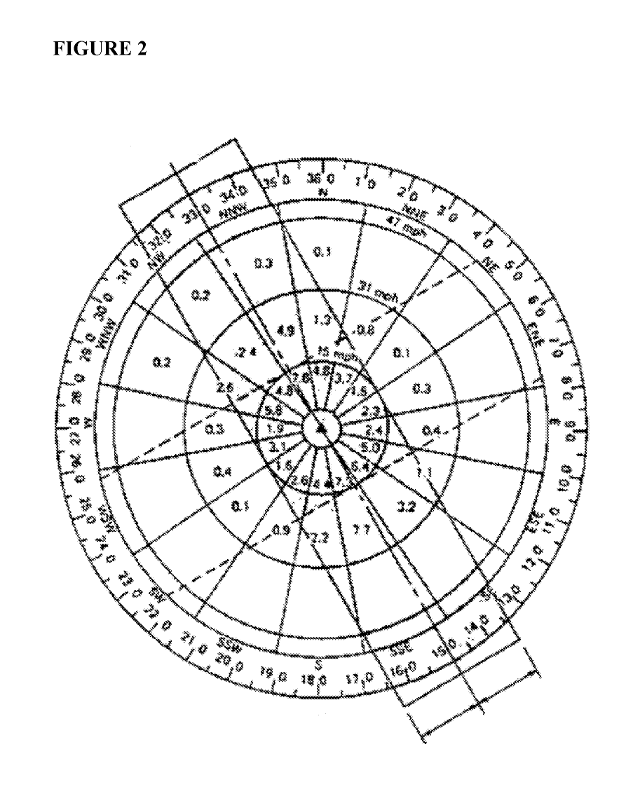

### DETAILED DESCRIPTION OF THE INVENTION

The method of the invention applied in computer produces solutions for two different types of analyses. First type of analysis calculates the optimum runway configuration that produces the highest usability factor automatically. In the second analysis method, on the other hand, the usability factor is calculated based on the previously identified runway orientations (e.g. orientations of 20°/200°, 30°/210° . . . 160°/340°), where it is possible to determine whether the selected runway orientations are suitable, in other words whether the usability factor is higher than the predetermined value (e.g. 95%).

The method of the invention applied in computer that performs the first and second types of analyses mentioned above are executed by an electronic device (e.g. smart devices such as a computer, tablet computer, smart phone, etc.) that contains a database (e.g. hard disk, flash disk, external hard disk, CD, internet database (e.g. cloud database) etc.), a control unit, a user interface, a data input interface (e.g. mouse, keyboard, touchscreen . . . ) and a display (monitor, touchscreen . . . ).

The data for a virtual wind rose, the data for a virtual runway template placed/rotated on said virtual wind rose, and a wind data table that contain information on the station number, observation date and time, the wind speed and direction blowing from 36 different directions with 10° intervals are stored in said database. Said table is preferably a table produced in Microsoft Access format. In order to prevent recounting and reprocessing of any wind data considered or counted during the calculation process, the Access tables with such capabilities (see control column) are used for this purpose. A small exemplary portion of the wind data is provided in Table 2 below.

TABLE 2
Example of Wind Data Table

| No | Year | Month | Day | Hour | WD(degrees) | WV(knot) | Control |
|---|---|---|---|---|---|---|---|
| 1 | 2009 | 1 | 1 | 0 | 320 | 1, 5 | 1 |
| 2 | 2009 | 1 | 1 | 1 | 310 | 4, 1 | 1 |
| 3 | 2009 | 1 | 1 | 2 | 330 | 3 | 1 |
| 4 | 2009 | 1 | 1 | 3 | 310 | 4, 1 | 1 |
| 5 | 2009 | 1 | 1 | 4 | 320 | 3, 6 | 1 |
| 6 | 2009 | 1 | 1 | 5 | 330 | 3 | 1 |
| 7 | 2009 | 1 | 1 | 6 | 320 | 3 | 1 |
| 8 | 2009 | 1 | 1 | 7 | 260 | 2, 5 | 1 |
| 9 | 2009 | 1 | 1 | 8 | 250 | 3 | 0 |
| 10 | 2009 | 1 | 1 | 9 | 240 | 4, 6 | 0 |
| 11 | 2009 | 1 | 1 | 10 | 230 | 4, 1 | 0 |

Said control unit might be any processor such as a microprocessor, microcontroller, etc. Said control unit is adapted for identifying the optimum runway orientation that produces the highest usability factor, for calculating the usability factor according to the previously identified runway orientations and for determining whether the runway orientations so selected are suitable by using the wind rose, runway template and number of wind observations available in the database.

Said user interface provides an interface between the user and the electronic device for calculating the optimum runway configuration that produces the highest usability factor and/or for calculating the usability factor according to the previously identified runway orientations and for determining whether the runway orientations so selected are suitable. The user is capable of selecting the desired type of analysis (first analysis or second analysis) over said interface, selecting the desired wind data table by clicking on the “Open File” key on the analysis screen that opens after selection and loading such database to the system. Said table can be available in the database of the electronic device as well as on an external memory unit. Upon loading the selected data table to the system, it is possible to display the total number of observations on both the first analysis screen and on the second analysis screen. Prior to calculations, all wind observations in Table 2 produced in Access format are coded as “0”.

The user can select the type of analysis he/she wishes to execute by the method of the invention applied in computer producing solutions for two different types of analyses by checking the respective box on the main page. The first type of analysis calculates the optimum runway configuration that produces the highest usability factor automatically. In the second analysis method, on the other hand, the usability factor is calculated depending on the previously identified runway orientations, and it is possible to determine whether the runway orientations so selected are suitable.

In the first type of analysis, the same cross-wind value is considered for all calculations intended for identification of the optimum runway orientation or orientations; but in the second type of analysis intended for determining the usability factor based on the previously identified runway configuration, it is possible to modify both the runway orientations and the permissible cross-wind value in any stage of the calculation.

First of all, the method steps executed by the electronic device in order to identify the optimum runway configuration that produces the highest usability factor, which represents the first type of analysis, are provided hereunder.

A method applied at the computer that enables identification of the optimum runway orientation that produces the highest usability factor by using an electronic device containing a database, a control unit, a data input interface, a user interface and a display, comprises, in its most basic form, the following steps:
determining the total number of observations by retrieving the wind data from the database,
obtaining the permissible maximum cross-wind value over the data input interface,
forming a runway template based on the permissible maximum cross-wind value for that plane by considering the smallest aircraft size that might land on the runway,
automatically rotating the runway template on a wind rose with 10° intervals starting from the true north,
calculating the usability factors in the following steps by evaluating the wind observations covered by the runway template for each shift in wind direction by 10° individually,
   calculating the cross-wind gale force for each of the 90° quadrants of a circle that represents the periphery of the wind rose based on the permissible maximum cross-wind value,
   calculating the number of observations to be considered separately as cross-wind for each quadrant,
   calculating the usability factors for each of the 18 different directions of the said runway template according to the information on the total number of wind observations, and the number of observations not covered by the first runway template and considered as cross-wind,
Making inquiry about whether the calculated usability factors are higher than a threshold value (e.g., from 95%),
   If the usability factor is higher than the said threshold value, then terminating the analysis and displaying the calculated usability factor and the runway orientation associated with such usability factor, in terms of degrees, on the display,
   if the usability factor is less than said threshold value, then continuing the calculation processes in order to calculate other runway orientations and new usability factor until the usability factor exceeds said threshold value.

In a preferred embodiment of the invention, the desired wind data table within the database is selected and loaded to the system by pressing the “Open File” button on the user interface. The control unit determines the total number of observations from such selected wind data table in order to be used for the processes to be disclosed hereunder. Then, the user enters the permissible maximum cross-wind value to the respective box on the user interface using a data input interface. Said value is the value entered according to the small type aircrafts that might probably land on the runway subjected to optimum runway orientation identification analysis and that would be affected by the cross-wind to the maximum extent.

In the next step, a runway template is created depending on the permissible maximum cross-wind value entered. For creating such template, said runway template is placed onto the wind rose in such manner that the vertical line passing through the center of the runway template coincides with the position of the permissible cross-wind value, entered to the user interface, on the wind rose. In a preferred embodiment of the invention, the wind rose of FAA containing 36 wind directions has been used for said wind rose on which the runway template will be positioned, but the wind observations have not been grouped in terms of percentage and the wind rose has not been subdivided into cells with the circles and lines. The radius of the wind rose used at the analyses have been assumed as 100 knots (nautical mile/hour) taking into consideration the highest probable wind value.

In the next step, the runway template determined according to the permissible cross-wind value is automatically rotated with 10° intervals starting from the true north and the usability factor is calculated individually for each 18 different directions of the runway template using the equation given hereunder:

$$\begin{matrix}UF ( α ) = \frac{{\sum }_{i = 0}^{360} {\sum }_{j = 0}^{100} {TW}_{ij} - {CW}_{T} ( α )}{{\sum }_{i = 0}^{360} {\sum }_{j = 0}^{100} {TW}_{ij}} & ( 1 ) \\ {CW}_{T} ( α ) = {\sum }_{i = θ}^{90} {{\sum }_{j = {wm}_{1} ( i )}}^{100} {CW}_{ij} ( α ) + {\sum }_{i = 90}^{180 - θ} {\sum }_{j = {wm}_{2} ( i )}^{100} {CW}_{ij} ( α ) + {\sum }_{i = 180 + θ}^{270} {\sum }_{j = {wm}_{3} ( i )}^{100} {CW}_{ij} ( α ) + {\sum }_{i = 270}^{360 - θ} {\sum }_{j = {wm}_{4} ( i )}^{100} {CW}_{ij} ( α ) & ( 2 )\end{matrix}$$

Here, α indicates the angle between the true north and the central line of the runway template, wherein α=0°, 10°, . . . , 170°; i indicates the wind orientations wherein i=0°, 10°, . . . , 360°; j indicates the wind speed wherein j=0, 1 . . . , 100; TW indicates the total number of wind observations; CW indicates the number of the cross-wind observations that exceed the permissible cross-wind limits; θ indicates the limit angle that produces the orientations covered by the runway template, and wm indicates the permissible cross-wind gale force.

The usability factor calculated in Equation 1 for each α value is obtained by subtracting the number of observations not covered by the created runway template and considered to be cross-wind from the total number of wind observations and then dividing the same to the total number of wind observations. Here, the wind observations that exceed the permissible wind limits and that blow from left and right of the central line of the runway template at angles other than the directions determined with angle θ have been considered as cross-wind. As the permissible cross-wind gale force (wm) varies at 10° intervals starting from angle θ, the number of observations to be considered as cross-wind has been calculated separately for each of the 90° quadrants. Then, the total number of cross-winds is obtained by adding the cross-wind observation numbers calculated for each quadrant as can be seen in Equation (2). The equations provided hereunder defines the variation of the cross-wind gale force in each quadrant. If the value so calculated is a fractional number, then it is rounded to the closest integer.

$$\begin{matrix}{wm}_{1} ( i ) = \frac{cw}{Sin ( i )} & ( 3 ) \\ {wm}_{2} ( i ) = \frac{cw}{Cos ( i - 90 )} & ( 4 ) \\ {wm}_{3} ( i ) = \frac{cw}{Sin ( i - 180 )} & ( 5 ) \\ {wm}_{4} ( i ) = \frac{cw}{Cos ( i - 270 )} & ( 6 )\end{matrix}$$

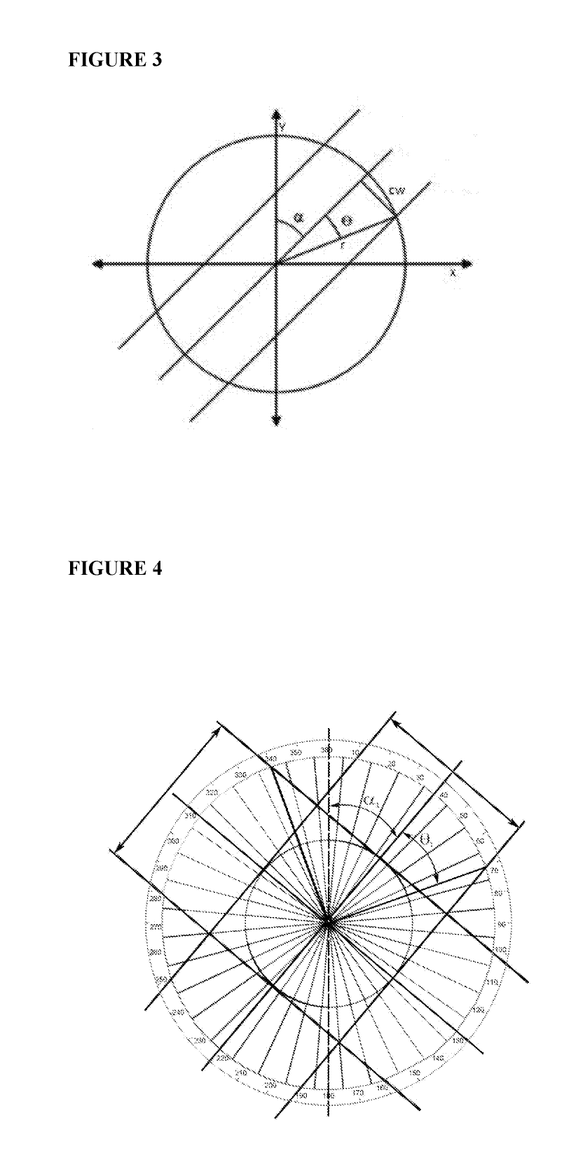

The angle θ illustrated in FIG. 3 and determines the orientations covered by the runway template is calculated using Equation (7) provided hereunder:

$$θ = arcsin \frac{cw}{r} \qquad ( 7 )$$

Here cw represents the permissible cross-wind component selected by the user; r represents the radius of the wind rose. The directions that exceed the permissible cross-wind limits are also determined using Equation (7). As the wind directions are given with 10° intervals in practice, the θ value so calculated is rounded to the closest 10°. The equation set defined above can be used for both types of analyses in both single and dual or triple runway configurations.

After determining the highest usability factor and the optimum runway orientation in the first analysis method, an inquiry is made in order to determine whether the usability factor calculated is equal to or higher than a predetermined value, e.g. 95%. If the usability factor is equal to or higher than 95%, the analysis is terminated and the calculated usability factor and the optimum runway orientation associated with such usability factor is displayed on the user interface in terms of degrees. If the usability factor is less than 95%, then the analysis continues and the optimum orientations for the second and, if required, third runway (or more) is determined as disclosed in the following paragraphs until a value higher than 95% is achieved. All these processes are executed automatically at the first analysis option.

If the usability factor of the first runway is less than 95%, then the process proceeds to determining the optimum orientation for the second runway. The wind observations considered as cross-wind for the first runway orientation, but covered by the second runway template is added to the wind observations covered by the first runway template, thus calculating a new usability factor, and the optimum orientation is identified for the second runway. In order to calculate such new usability factor, the control unit creates a second runway template according to the same permissible cross-wind component entered by the user for the first runway orientation, and then rotates such second runway template in 18 directions once more in order to determine the orientation (that is to say the optimum orientation for the second runway) that covers the highest number of cross-wind observations that fall outside the first runway template. Then a new usability factor is calculated by adding the observations that remain within the second runway template to the observations covered by the first runway template, and such new usability factor is displayed on the user interface.

In the next step, an inquiry is made so as to determine whether the usability factor is less than 95%; if the usability factor is still less than 95%, then the similar process, that is to say calculation of the new usability factor by adding the wind observations considered as cross-wind for the first two runway orientations but covered by the third runway template to the wind observations covered by the first and second runway template, is repeated automatically in order to identify the third runway orientation. Any person skilled in the art is capable of performing optimum runway orientation and usability factor calculations also for more than three runways easily in accordance with the explanations provided above.

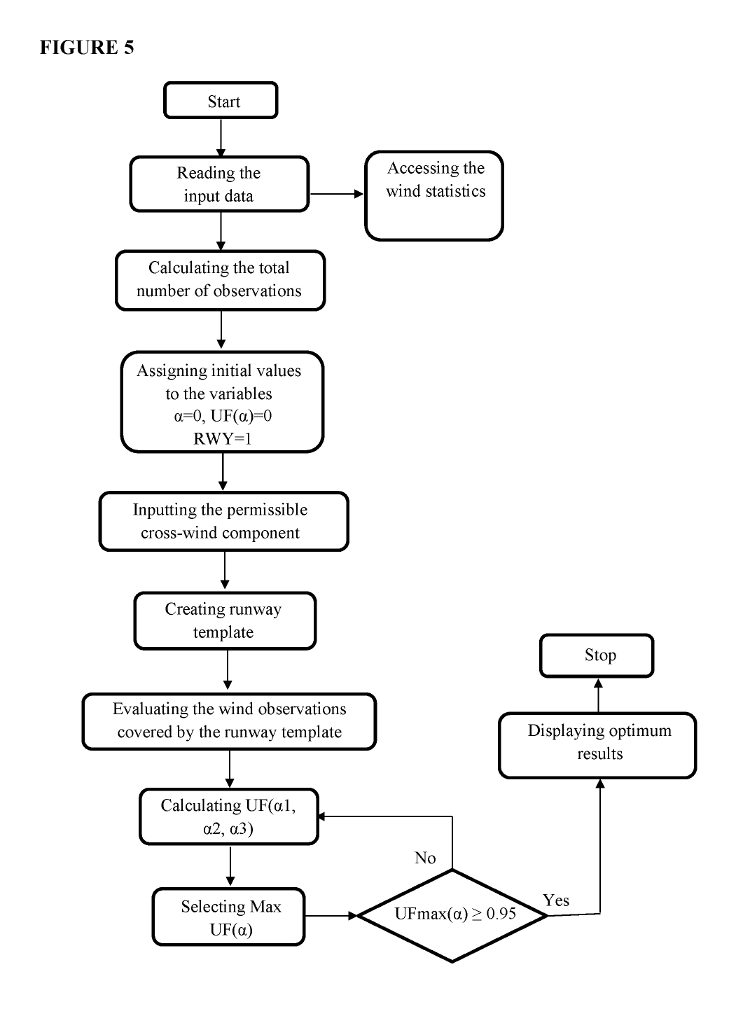

The flow chart related to the operating logic of the first type of analysis is provided in FIG. 5. Each process step is defined hereunder in respective orders:
start-up the system,
read the wind statistics in Access format as input data,
calculate and display the total number of observations,
define the initial values of the variables to the system (Here, a indicates the wind direction in terms of degrees, UF(α) indicates the usability factor and the RWY indicates the number of runways for which orientation will be calculated),
enter the permissible cross-wind value according to the critical aircraft selected (according to the small type aircrafts that might probably land on the runway subjected to optimum runway orientation identification analysis and that would be affected by the cross-wind to the maximum extent),
create the runway template according to the selected cross-wind value,
evaluate the wind observations covered by the runway template for each variation of direction by 10° and calculate the usability factors,
Select the highest usability factor,
if the value is less than 0.95, then calculate the highest usability factor value obtained by adding the second runway. If the value is still less than 0.95, then repeat the process for the third runway,
If the highest usability factor achieved in any step is higher than 0.95, then display the optimum runway orientation or orientations and the highest usability factors obtained by addition of each runway on the display,
finalize the analysis.

The method steps executed by the electronic device in order to identify the usability factor based on the previously identified runway configuration, which represents the second type of analysis, are provided hereunder.

A method applied at the computer that enables identification of the usability factor based on the previously identified runway configuration by using an electronic device containing a database, a control unit, a data input interface, a user interface and a display, comprises, in its most basic form, the following steps;
determining the total number of observations by retrieving the wind data from the database,
obtaining the permissible maximum cross-wind value over the data input interface,
forming a runway template based on the permissible maximum cross-wind value for that plane by considering the smallest aircraft size that might land on the runway,
Automatically rotating the runway template on a wind rose with 10° intervals starting from the true north,
calculating the usability factors in the following steps by evaluating the wind observations covered by the runway template for each shift in wind direction by 10° individually,
   calculating the cross-wind gale force for each of the 90° quadrants of a circle that represents the periphery of the wind rose based on the permissible maximum cross-wind component,
   calculating the number of observations to be considered separately as cross-wind for each quadrant,
   calculating the usability factors for each of the 18 different directions of the said runway template according to the information on the total number of wind observations, and the number of observations not covered by the first runway template and considered as cross-wind,
listing all calculated usability factors and displaying the same on user interface,
Making inquiry about whether the usability factor for any of the directions specified on the list formed for the first runway is selected and whether the permissible cross-wind limit for the second runway is entered over the data input interface for calculation of the dual runway configuration,
   if said selection and entering operation is performed, then adding the observations considered as cross-wind for the first runway but covered by the second runway template to the observations covered by the first runway template selected, and listing the usability factors for 18 different dual runway configurations and displaying the same on the display,
   if not performed, then terminating the process
Making inquiry about whether two separate usability factors that belong to any of the directions specified on the list formed for the first and second runway is selected, and whether the permissible cross-wind limit for the third runway is entered over the data input interface for calculation of the triple runway configuration,
   if said selection and entering operation is performed, then adding the observations considered as cross-wind for the first and second runway but covered by the third runway template to the observations covered by the first and second runway template selected, and listing the usability factors for 18 different triple runway configurations and displaying the same on the display,
   if not performed, then terminating the process.

In the second analysis method, on the other hand, the results (usability factors) obtained from the equations (Equation 1-7) defined above according to the entered cross-wind value are listed for 18 different directions (e.g. 20°/200°, 30°/210° . . . 160°/340°) in the UF (RWY1) column of the table at the bottom section of the second analysis display just like the usability factors. The bottommost line of this column displays the runway orientation and UF value that produces the highest (max) usability factor.

Upon double clicking on the usability factor for any of the 18 directions or for the optimum runway orientation, the data on the selected direction and the usability factor appear in the “1^{st} Runway orientation” and “1^{st} Usability factor” windows located on the top section of the display. By virtue of this property, the user is capable of choosing any desired option out of the 18 available options as the main runway orientation and perform calculations for the second and third runway orientations as disclosed in the subsequent steps. Although all of the wind observations were initially coded as “0” in the Access table, the wind observations that remain within the runway template for the selected direction after calculations are assigned as “1” in the Access table.

After choosing the preferred runway orientation and the permissible cross-wind component for the second runway from the said list (in other words after such selections appear in the “1^{st} Runway orientation” and “1^{st} Usability factor” windows), it is possible to calculate the usability factors for the dual runway configuration. For such calculation, clicking on “Calculate 2” key after entering the permissible cross-wind value for the second runway to the “2^{nd} Permissible cross-wind component” box lists the usability factors for 18 different dual runway configurations in the UF (RWY2) column. The bottommost line of this column again displays the orientation and UF value of the second runway that produces the highest (max) usability factor. The usability factors obtained at this step are calculated by adding the observations considered as cross-wind for first runway but covered by the second runway template to the observations covered by the first runway template selected. The observations added to the first usability factor are also coded as 1 in the Access table. The usability factors for 18 different dual runway configurations are calculated by repeating this process.

If desired by the user, the same calculation procedure is executed also for the triple runway configuration. As some wind observations can be cove red by two or three runway templates, such observations are coded as “1” when it is covered for the first time so as to prevent counting of the same for two or three times. In order to ensure this, the tables for the wind observations are produced in Access format. By virtue of this cumulative feature of the Access tables, the same equation set can be used for calculating acceptable wind coverage at single, dual or triple runway configurations.

In order to identify the triple runway configuration, after choosing one of the usability factors for dual runway configurations from the list (in other words, specified within the “2^{nd} Runway orientation” and “2^{nd} Usability factor” windows), and entering the permissible cross-wind value for the third runway to the respective box, the usability factors for triple runway configurations are listed by clicking the “Calculate 3” key. The user chooses any desired triple runway configuration from 18 different options taking into consideration the condition of fulfilling the usability factor of 95% at minimum. The usability factors for the previously selected first and second runway orientations are displayed in UF (RWY1) and UF (RWY2) columns of the results table at the bottom part of the display with a different color (e.g. green). The user is also capable of modifying his choices at any step and make new inquiries.

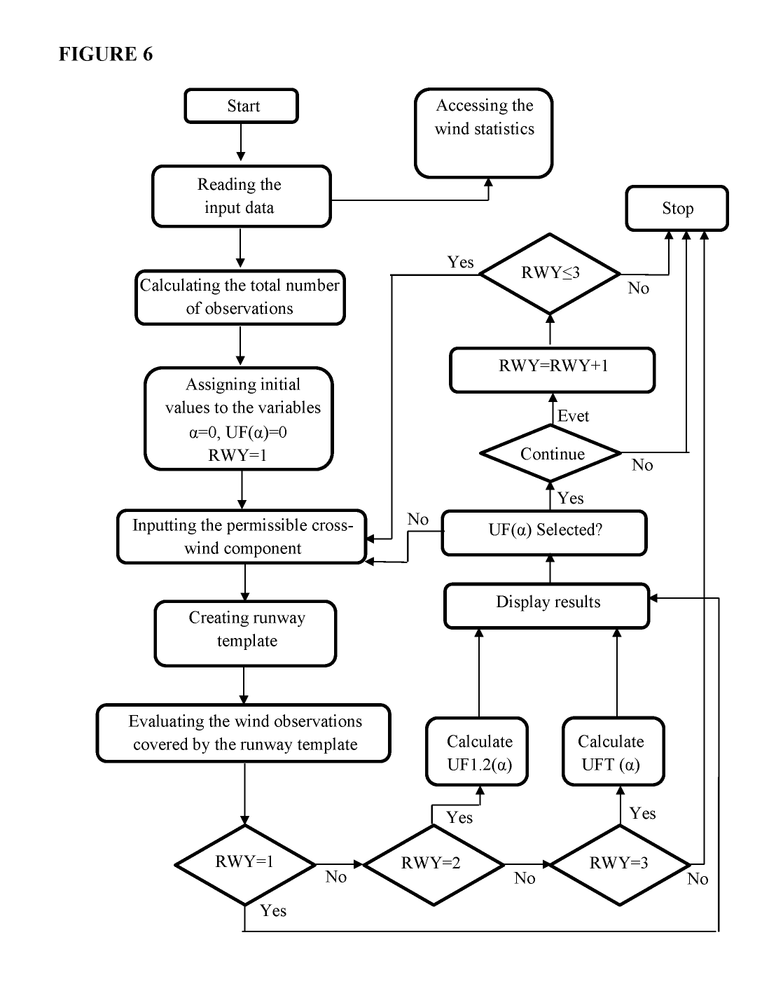

The flow chart related to the operating logic of the second type of analysis is provided in FIG. 6. Each process step is defined hereunder in respective orders:
start-up the system,
Read the wind statistics in Access format as input data,
calculate and display the total number of observations,
Define the initial values of the variables to the system (Here, a indicates the wind direction in terms of degrees, UF(α) indicates the usability factor and the RWY indicates the number of runways for which orientation will be calculated),
enter the permissible cross-wind value according to the critical aircraft selected (according to the small type aircrafts that might probably land on the runway subjected to optimum runway orientation identification analysis and that would be affected by the cross-wind to the maximum extent),
create the runway template according to the selected cross-wind value,
Evaluate the wind observations covered by the runway template for each variation of direction by 10° and calculate the usability factors.
If RWY=1, that is to say if the usability factors will be obtained for a single runway, then display the results calculated in the preceding step,
If any of the UF(α) values within the results is not selected, then return to permissible cross-wind input section and enter a new value,
If UF(α) is selected and if the process will not continue, then terminate the process; if the process will continue for dual runway configuration, then increase the RWY parameter by one,
If RWY≤3, then enter the new cross-wind value for the second runway,
Create the new runway template,
Calculate the usability factors for RWY=2 using the same equation set,
Display the results for the second runway,
Terminate the process if the operation will not continue.

The last seven steps will be repeated if any triple runway configuration is desired. The step “Is UF(α) selected?” allows to renew of the analysis by modifying the permissible cross-wind component and the runway orientation, or to continue the analysis for dual and triple runway configurations. The step “Continue”, on the other hand, allows to finish the calculation steps at any stage depending on the user preferences. That is to say, the analyses can be repeated by modifying the permissible cross-wind limit or the selected runway orientation at any stage of the analysis process. Furthermore, although the model is designed for triple runway layouts, it might also be used for single or dual runway configurations and it is possible to stop the program at this stage after completion of the analyses.

The reliability of the developed model has been tested on three numerical examples. The analyses have been performed using the wind data for Istanbul Ataturk Airport. In the first example, the optimum runway orientation has been identified using both the method of the invention, and the traditional Wind Rose method of the FAA in order to test the reliability of the model. In the second analysis, the data set used in the first example has been modified with aim to demonstrate how the FAA assumption mentioned above reduces the accuracy especially in cases when the wind observations do not have homogenous distribution. Finally, the third example aims to demonstrate the flexibility of analysis that the method of the invention provides to the user. AutoCAD program was used in the analyses performed using the FAA technique, which is known to produce the moist accurate results in the previous analyses.

During the analyses performed in the first example taking the cross-wind component as 10 knots, the optimum runway orientation was found as 010°/190° with both methods while the usability factor was calculated to be 97.81% using the method of the invention, and 96.98% using the Wind Rose method. The difference between the values arises from the assumption used in the FAA method that the gale forces and number of occurrences in each cell have homogenous distribution. The accuracy of the results obtained with the wind rose method declines as the number of cells partially covered by the runway template, and their coverage percentage increases. Therefore, the error that might arise from the FAA assumption is completely eliminated in the method of the invention as each wind observation is considered individually without any grouping.

The second analysis has been performed in order to demonstrate the accuracy of the method of the invention when there is non-homogenous wind distribution. For this purpose, the data set used in the first analysis has been modified. Accordingly, all wind observations that remain within the cells containing wind observations higher than the speed value of 10 knots have been assigned to the highest value of the wind speed range of the respective cell. While the results obtained with the Wind Rose at the measurements made with the edited data set were identical with the results from the first analysis, the usability factor was reduced to 96.09% value with the method of the invention, although the optimum runway orientation remained the same. As the analysis is performed by grouping the wind observations in the traditional Wind rose model, the usability factor and the optimum runway orientation remained the same. In spite of this, when the identification of the optimum runway orientation problem was solved with a wind data set that contain large number of high speed wind observations and different dominant wind directions, the results obtained with the method of the invention will have significant differences compared to the traditional methods.

The final analysis was performed in order to demonstrate the flexibility of the method of the invention. In the stage of identifying the suitable runway orientations prior to construction of the airport elements, the airport planner might need to analyze various runway configurations due to some restrictions concerning the environment and the air space. In this respect, the method of the invention offers the planner the means to test various alternates and discover the optimum solution in practice. Table 3 gives the results obtained with the method of the invention where different scenarios were tested.

TABLE 3
Calculation of Usability Factor for Previously Selected Runway
Configurations

| Previously Selected | | |
|---|---|---|
| Orientations | cw | UF |
| 0°/180° | 10 knots | 97.08% |
| 110°/290° | 13 knots | 99.79% |
| 10°/190° | | |
| 30°/210° | 15 knots | 99.99% |
| 90°/270° | | |
| 150°/330° | | |

1. A method applied with computer comprising a database, a control unit, a data input interface, a user interface and a display for allowing identification of the optimum runway orientation that produces the highest usability factor by using an electronic device, wherein the method is characterized with the steps set forth hereunder, in its most basic form;
determining the total number of observations by retrieving the wind data from the database,
obtaining the permissible maximum cross-wind value over the data input interface,
forming a runway template based on the permissible maximum cross-wind value for that plane by considering the smallest aircraft size that might land on the runway,
Automatically rotating the runway template on a wind rose with 10° intervals starting from the true north,
calculating the usability factors by evaluating the wind observations covered by the runway template for each shift in wind direction by 10° individually,
Making inquiry about whether the calculated usability factors are higher than a threshold value,
If the usability factor is higher than the said threshold value, then terminating the analysis and displaying the calculated usability factor and the runway orientation associated with such usability factor, in terms of degrees, on the display.

2. A method applied with computer according to claim 1, characterized with the following steps;
Creating a second runway template according to same permissible cross-wind component entered for the first runway orientation,
Calculating a new usability factor by adding the wind observations considered as cross-wind for the first runway orientation, but covered by the second runway template to the wind observations covered by the first runway template
in order to find the optimum orientation for the second runway if the usability factor is less than said threshold value in the step “Making inquiry about whether the calculated usability factors are higher than a threshold value”.

3. A method applied with computer according to claim 2, characterized with the following steps;
Making inquiry about whether the usability factor is less than the threshold value,
if the usability factor is less than said threshold value, in order to identify the third runway orientation; creating a second runway template according to same permissible cross-wind component entered for the first runway orientation, and calculating a new usability factor by adding the wind observations considered as cross-wind for the first two runway orientations, but covered by the third runway template to the wind observations covered by the first and second runway templates
after the step “Calculating a new usability factor by adding the wind observations considered as cross-wind for the first runway orientation, but covered by the second runway template to the wind observations covered by the first runway template”.

4. A method applied with computer according to claim 1, characterized with the step of placing said runway template onto the wind rose in such manner that the vertical line passing through the center of the runway template coincides with the position of the permissible cross-wind value, entered to the user interface, on the wind rose in the step “Forming a runway template based on the permissible maximum cross-wind value for that plane by considering the smallest aircraft size that might land on the runway”.

5. A method applied with computer according to claim 1, characterized with the following steps;
calculating the cross-wind gale force for each of the 90° quadrants of a circle that represents the periphery of the wind rose based on the permissible maximum cross-wind value,
calculating the number of observations to be considered separately as cross-wind for each quadrant,
calculating the usability factors for each of the 18 different directions of the said runway template according to the information on the total number of wind observations, and the number of observations not covered by the first runway template and considered as cross-wind
in the step “calculating the usability factors by evaluating the wind observations covered by the runway template for each shift in wind direction by 10° individually”.

6. A method applied with computer comprising a database, a control unit, a data input interface, a user interface and a display for allowing identification the usability factor based on the previously identified runway configuration by using an electronic device, wherein the method is characterized with the steps set forth hereunder, in its most basic form;
determining the total number of observations by retrieving the wind data from the database,
obtaining the permissible maximum cross-wind value over the data input interface,
forming a runway template based on the permissible maximum cross-wind value for that plane by considering the smallest aircraft size that might land on the runway,
Automatically rotating the runway template on a wind rose with 10° intervals starting from the true north,
calculating the usability factors by evaluating the wind observations covered by the runway template for each shift in wind direction by 10° individually,
listing all calculated usability factors and displaying the same on user interface.

7. A method applied with computer according to claim 6, characterized with the following steps;
calculating the cross-wind gale force for each of the 90° quadrants of a circle that represents the periphery of the wind rose based on the permissible maximum cross-wind value,
calculating the number of observations to be considered separately as cross-wind for each quadrant,
calculating the usability factors for each of the 18 different directions of the said runway template according to the information on the total number of wind observations, and the number of observations not covered by the first runway template and considered as cross-wind
in the step “calculating the usability factors by evaluating the wind observations covered by the runway template for each shift in wind direction by 10° individually”.

8. A method applied with computer according to claim 6, characterized with the steps of making inquiry about whether the usability factor for any of the directions specified on the list formed for the first runway is selected and whether the permissible cross-wind limit for the second runway is entered over the data input interface for calculation of the dual runway configuration,
if said selection and entering operations are performed, then adding the observations considered as cross-wind for the first runway but covered by the second runway template to the observations covered by the first runway template selected, and listing the usability factors for 18 different dual runway configurations and displaying the same on the display,
if not performed, then terminating the process
after the step “Listing all calculated usability factors and displaying the same on user interface”.

9. A method applied with computer according to claim 8, characterized with the steps;
Making inquiry about whether two separate usability factors that belong to any of the directions specified on the list formed for the first and second runway is selected, and whether the permissible cross-wind limit for the third runway is entered over the data input interface for calculation of the triple runway configuration,
if said selection and entering operation is performed, then adding the observations considered as cross-wind for the first and second runway but covered by the third runway template to the observations covered by the first and second runway template selected, and listing the usability factors for 18 different triple runway configurations and displaying the same on the display,
if not performed, then terminating the process
after the step “making inquiry about whether the usability factor for any of the directions specified on the list formed for the first runway is selected and whether the permissible cross-wind limit for the second runway is entered over the data input interface for calculation of the dual runway configuration”.

10. A method applied with computer according to any of claim 2, characterized with the following steps;
calculating the cross-wind gale force for each of the 90° quadrants of a circle that represents the periphery of the wind rose based on the permissible maximum cross-wind value,
calculating the number of observations to be considered separately as cross-wind for each quadrant,
calculating the usability factors for each of the 18 different directions of the said runway template according to the information on the total number of wind observations, and the number of observations not covered by the first runway template and considered as cross-wind
in the step “calculating the usability factors by evaluating the wind observations covered by the runway template for each shift in wind direction by 10° individually”.

11. A method applied with computer according to claim 3, characterized with the following steps;
calculating the cross-wind gale force for each of the 90° quadrants of a circle that represents the periphery of the wind rose based on the permissible maximum cross-wind value,
calculating the number of observations to be considered separately as cross-wind for each quadrant,
calculating the usability factors for each of the 18 different directions of the said runway template according to the information on the total number of wind observations, and the number of observations not covered by the first runway template and considered as cross-wind
in the step “calculating the usability factors by evaluating the wind observations covered by the runway template for each shift in wind direction by 10° individually”.
